(19) United States
(12) Patent Application Publication
(10) Pub. No.: US 2025/0006067 A1
(43) Pub. Date: Jan. 2, 2025

(54) SYSTEM FOR ASSISTING WITH OPERATIONS TO BE EFFECTED IN AN AIRCRAFT DURING A PHASE OF MOVING OVER THE GROUND IN AN AIRPORT

(71) Applicants: Airbus Operations SAS, TOULOUSE (FR); Airbus Operations Limited, FILTON (GB)

(72) Inventors: Gabriel LOUPIAC, TOULOUSE (FR); Dylan REYNOLDS, TOULOUSE (FR)

(21) Appl. No.: 18/757,967

(22) Filed: Jun. 28, 2024

(30) Foreign Application Priority Data
Jun. 30, 2023 (FR) 2306976

(51) Int. Cl. G08G 5/06; G08G 5/00

(52) U.S. Cl. CPC G08G 5/06; G08G 5/0026

(57) ABSTRACT

A method for assisting with operations to be effected during a phase of movement over the ground in an airport. The method comprises: obtaining, for at least one phase of movement over the ground performed in an airport, by an aircraft of a fleet, data each representative of one event of a list of events, and a geolocation point of the event and a condition of the phase of movement over the ground; determining, for at least one route, an occurrence rate of each event realized on the route, and per geolocation point, solely on the basis of the data for which the condition of the phase of movement over the ground meets a predefined criterion. A datum representative of a determined occurrence rate and of an associated geolocation point are provided. Also a system.

### CROSS-REFERENCES TO RELATED APPLICATIONS

This application claims the benefit of French Patent Application Number 2306976 filed on Jun. 30, 2023, the entire disclosure of which is incorporated herein by way of reference.

### FIELD OF THE INVENTION

The present invention relates to a system for assisting with operations to be effected in an aircraft during a phase of movement over the ground in an airport, and to a method implemented by said system. The present invention in particular relates to the field of assistance with making a decision to effect operations while moving over the ground and aims to display a graphical representation of the taxiways of an airport allowing, at each geolocation point of an airport, a number of identical events realized during previous phases of movement over the ground by an aircraft fleet to be viewed.

### BACKGROUND OF THE INVENTION

In an airport, aircraft move over the ground during phases of movement over the ground, such as taxiing phases or phases of movement over a take-off or landing runway, whether before take-off or after landing. Such movement over the ground allows the aircraft to travel a distance between a start point, such as a departure gate in the case of take-off, to an end point, such as a runway threshold in the case of take-off. A number of operations must be performed in order to travel said distance and to prepare the aircraft for take-off or allow it to stop. However, certain of these operations must be initiated, between the start point and the end point, at an optimal time making it possible, for example, to limit cost, fuel consumption, wear of consumables such as brakes and tires or time spent between the start point and take-off.

In particular, the phase of movement over the ground does not require two propulsion engines of the aircraft to be switched on, since a single propulsion engine is enough to allow the aircraft to move over the ground. Switching on only one propulsion engine thus allows fuel to be saved. However, aircraft take-off requires the second propulsion engine to be switched on and ready. In other words, a warm-up time is required between when the second propulsion engine is switched on and take-off. Thus, the operation of switching on the second propulsion engine must be performed at an optimal time between the start point and the end point in order to save fuel while minimizing waiting time at a threshold or stopping point of the runway.

However, such an optimal time may prove difficult to determine, in particular because of taxiway configuration, which varies greatly from airport to airport. Furthermore, the time required to travel the taxiways of an airport may vary depending on particularities related to climate, to the busyness of the airport, or even to airport traffic rules. It is thus difficult for a pilot to determine when, and therefore where in the airport, to perform the operation in question.

It would thus be desirable to mitigate these drawbacks of the prior art.

It would in particular be desirable to provide a solution making it possible to assist with the decision regarding the place, in an airport, where to perform an operation.

### SUMMARY OF THE INVENTION

One object of the present invention is to provide a method for assisting with operations to be effected in an aircraft on the ground in an airport, the method comprising obtaining, for at least one phase of movement over the ground performed in a given airport, by an aircraft of a fleet of aircraft, and depending on a route travelled, one or more data each representative of one event realized during the phase of movement over the ground, the event being chosen from a list of predefined events, and a geolocation point at which the event was realized; obtaining, in association with each datum representative of an event, at least one datum concerning a condition or conditions of the phase of movement over the ground; determining, for at least one predetermined route, an occurrence rate of each predefined event realized during a phase of movement over the ground along the predetermined route, and per geolocation point, on the basis of the one or more data obtained, the occurrence rate of each predefined event being determined solely on the basis of the data representative of the predefined event for which the at least one condition of the phase of movement over the ground meets at least one predefined criterion; and providing a datum representative of at least one determined occurrence rate and at least one geolocation point associated with said occurrence rate.

Thus, it is possible to easily determine an occurrence rate of a predefined event previously realized by other aircraft during phases of movement over the ground in the same airport and to determine the place of realization. This allows a pilot to easily decide on a presumed ideal location to perform an operation based on previous events.

According to one particular embodiment, providing a datum representative of at least one determined occurrence rate and at least one geolocation point associated with said occurrence rate comprises generating a graphical representation of each determined occurrence rate, via superposition on a map of the taxiways of the airport.

According to one particular embodiment, the method further comprises determining, for a given start point and a given end point, a passage occurrence rate of at least one aircraft of the fleet per geolocation point of at least one route travelled during a phase of movement over the ground between the given end point and the given start point and further comprises providing a datum representative of at least one determined passage occurrence rate and at least one geolocation point associated with said passage occurrence rate.

According to one particular embodiment, providing a datum representative of at least one determined passage occurrence rate and at least one geolocation point associated with said passage occurrence rate comprises generating a graphical representation of each determined passage occurrence rate, via superposition on a map of the taxiways of the airport.

According to one particular embodiment, a first event in the list of predefined events is switching on a second propulsion engine of the aircraft.

According to one particular embodiment, a second event in the list of predefined events is a temperature state of the second propulsion engine sufficient to permit take-off.

According to one particular embodiment, the at least one predefined criterion is a time period of the day and/or a day of the week and/or a time period of the year and/or an aircraft type and/or a meteorological criterion.

According to one particular embodiment, the method further comprises selecting at least one geolocation point at which the occurrence rate of a predefined event is highest, and initiating automatic piloting comprising effecting, at said selected geolocation point, an operation associated with said predefined event.

The invention also relates to a system for assisting with operations to be effected on the ground, in an aircraft, during a phase of movement over the ground performed in a given airport, the system comprising electronic circuitry configured to: obtain, for at least one phase of movement over the ground performed in a given airport, by an aircraft of a fleet of aircraft, and depending on a route travelled, one or more data each representative of one event realized during the phase of movement over the ground, the event being chosen from a list of predefined events, and a geolocation point at which the event was realized; obtain, in association with each datum representative of an event, at least one datum concerning a condition or conditions of the phase of movement over the ground; determine, for at least one predetermined route, an occurrence rate of each predefined event realized during a phase of movement over the ground along the predetermined route, and per geolocation point, on the basis of the one or more data obtained, the occurrence rate of each predefined event being determined solely on the basis of the data representative of the predefined event for which the at least one condition of the phase of movement over the ground meets at least one predefined criterion; and provide a datum representative of at least one determined occurrence rate and at least one geolocation point associated with said occurrence rate.

### BRIEF DESCRIPTION OF THE DRAWINGS

The above-mentioned features of the invention, as well as others, will become more clearly apparent on reading the following description of at least one example of embodiment, said description being given with reference to the appended drawings, in which:

FIG. 1 schematically illustrates a system for assisting with operations to be effected by an aircraft during a phase of movement over the ground in an airport;

FIG. 2 schematically illustrates the aircraft;

FIG. 3 schematically illustrates a chart resulting from a graphical representation of each occurrence rate;

FIG. 4 schematically illustrates one example of a hardware platform allowing a data-managing system of the assisting system to be implemented in the form of electronic circuitry;

FIG. 5A schematically illustrates first steps of an assisting method implemented by the assisting system;

FIG. 5B schematically illustrates second steps of the assisting method implemented by the assisting system;

FIG. 6 schematically illustrates optional filtering steps of the assisting method; and

FIG. 7 schematically illustrates filtering steps of the assisting method.

### DETAILED DESCRIPTION OF THE PREFERRED EMBODIMENTS

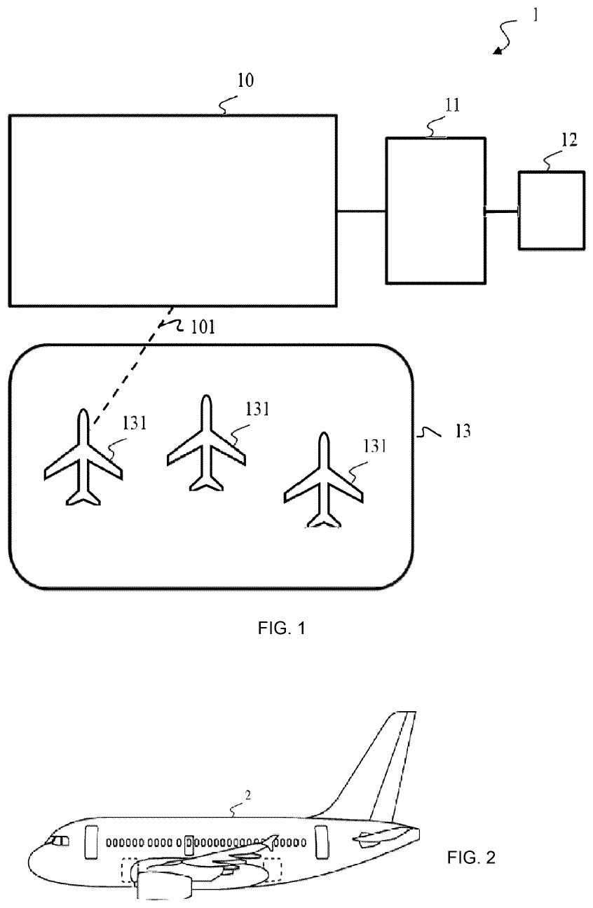

FIG. 1 thus schematically illustrates a system 1 for assisting with operations effected during a phase of movement over the ground in an airport by an aircraft 2 benefiting from the assisting system 1. A phase of movement over the ground is a period during which an aircraft moves over the ground in an airport, such as for example during a taxiing phase; during a phase of preparing for take-off, before the wheels of aircraft 2 lose contact with the ground; or during a landing phase, after the wheels of the aircraft 2 have made contact with the ground. The expression “phase of movement over the ground” is understood, in the context of the invention, to mean any operation during which at least one wheel of the aircraft 2 is in contact with the ground. A phase of movement over the ground may for example comprise a movement before take-off or after landing, in order to travel a distance between a start point, such as a boarding gate, and an end point, such as a runway threshold. According to another example, a phase of movement over the ground comprises a braking operation after the wheels of aircraft 2 have touched the ground during a landing. An operation effected during a phase of movement over the ground is performed by an autopilot or by a pilot in order to allow an aircraft to move over the ground and to prepare for a take-off or stoppage of said aircraft. Switching on the second propulsion engine of an aircraft and braking an aircraft are two examples of operations.

The assisting system 1 comprises a data-managing system 10, allowing data to be collected, processed and provided. The data-managing system 10 comprises a list of predefined events that may or must be realized during a phase of movement over the ground. A predefined event may be an operation, such as switching on the second propulsion engine or actuating a brake; a change in a state of a parameter, for example a temperature of the second propulsion engine reaching or exceeding a predefined threshold; or a met condition, for example a second engine ready to perform a take-off or even contact between the tires and the ground. Each predefined event in the list is associated with at least one operation to be effected and makes it possible to give an indication that an operation has been effected or an indication that a result is being waited for after said operation has been effected.

The data-managing system 10 is configured to obtain, from at least one aircraft 131 of a fleet 13, at least one datum representative of an event in the list of predefined events. Each obtained datum is representative of an event realized during a phase of movement over the ground performed by an aircraft 131 of the fleet 13 in a given airport. The data-managing system 10 is further configured to obtain, for each datum representative of an event, a datum representative of a route travelled during the phase of movement over the ground in question, between a start point and an end point.

The data representative of the events are obtained from databases of the fleet 13 of aircraft 131, such as, for example, the ACMS, DAR and FOMAX databases of each aircraft 131 (ACMS, DAR and FOMAX standing for Aircraft Condition Monitoring System, Direct Access Recording, and Flight Operations and Maintenance Exchanger, respectively).

According to one embodiment, the data representative of the events are obtained via a wireless communication link 101 between an aircraft 131 of the fleet 13 and the data-managing system 10. Such data may be obtained in real time, periodically; at the end of a phase of movement over the ground; or at the end of a flight, or in other words at the end of a phase of movement over the ground following a landing. According to one embodiment, said data are obtained via a data storage medium that is physically transported between the aircraft 131 and a communication interface of the data-managing system 10. The physical transport is for example performed by a pilot of the aircraft 131 at the end of a flight, when the aircraft 131 has stopped.

The data-managing system 10 is further configured to obtain, for each datum representative of an event, a geolocation datum regarding the geolocation, in the airport, at which said event was realized. According to one embodiment, the geolocation datum is obtained in association with the datum representative of the event realized at said geolocation, for example when the datum representative of the event and the associated geolocation datum are generated conjointly.

According to one embodiment, the geolocation datum is obtained separately from the datum representative of the event, and in association with a timestamp. The datum representative of the event is in this case obtained in association with a timestamp. The data-managing system 10 associates each datum representative of an event generated by an aircraft 131 with the geolocation datum of the same aircraft 131 that has the same timestamp. For example, the data representative of an event obtained from an ACMS database are associated with geolocation data obtained from an ADS-B database of the same aircraft 131 (ADS-B standing for Automatic Dependent Surveillance-Broadcast).

Each geolocation datum is converted into a geolocation point in the airport placed on a taxiway. A geolocation point in the airport is defined as a segment of the airport's surface having a specific area. A geolocation point in the airport that is further placed on a taxiway is a geolocation point the coordinates of which are identified as being in a location on a taxiway. To this end, the data-managing system 10 comprises or obtains a database of the taxiways of the airport including all of the airport geolocation points placed on the taxiways. The data-managing system 10 then determines, for each obtained geolocation datum associated with a datum representative of an event, the nearest airport geolocation point located on a taxiway, the assumption being that the aircraft 131 will never be directed over or stop on non-navigable terrain. The airport's taxiways include parking areas at the boarding gates.

The data-managing system 10 is further configured to determine, for at least one predefined event in the list of predefined events, an occurrence rate of said event, per geolocation point. The occurrence rate is further determined for at least one specified route, or in other words taking into account data representative of an event that is realized during a phase of movement over the ground along said at least one specified route. The assisting system 1 is further configured to provide a datum representative of at least one determined occurrence rate and at least one geolocation point associated with said occurrence rate.

According to one embodiment, the assisting system 1 further comprises a display 12, which may be arranged in the aircraft 2. The display 12 is configured to graphically represent each occurrence rate of at least one predefined operation. Each occurrence rate is for example represented on a map of the airport's taxiways, by an indicator positioned spatially, with respect to said taxiways, depending on its geolocation point in the airport, the indicator having a characteristic representative of the occurrence rate in question.

It is thus possible for a pilot to easily see a statistical distribution associating, with each geolocation point of the airport, an occurrence rate of a predefined event specific to that geolocation point. For example, a pilot who desires to obtain an indication of the optimal location to switch on the second engine of the aircraft 2 on a specified route that she or he must take before a take-off may view at which airport geolocation point the highest number of aircraft 131 of the fleet 13 switched on the second propulsion engine on said route, during previous phases of movement over the ground. The pilot may further view other geolocation points on the route at which many aircraft 131 turned on their second propulsion engine and other locations at which few or no aircraft 131 turned on their second propulsion engine. The pilot may then decide to perform the operation of switching on the second engine at a geolocation point on the route where it seems most appropriate to perform said operation, even if she or he is unfamiliar with the airport in question, by taking into account previous phases of movement over the ground. In another example, the pilot may view at which geolocation point on a runway in the airport the highest number of aircraft 131 placed their tires in contact with the ground and/or initiated braking. This for example allows the pilot to make a decision more easily in order to reduce wear of the brakes and wear of the tires.

Furthermore, the pilot may select the geolocation point where it seems most appropriate to initiate an automatic piloting, for example at least one geolocation point at which the occurrence rate of a predefined event is highest. The automatic piloting then comprises performing, at said selected geolocation point, an operation associated with the predefined event. In the case where a plurality of geolocation points are associated with the same occurrence rate, in other words with an occurrence rate of given value, it is possible to use an additional criterion to select one geolocation point among said plurality of geolocation points.

According to one embodiment, the data-managing system 10 is further configured to determine an occurrence rate of passage of at least one aircraft 131 of the fleet 13 through each geolocation point of the airport, and for a given start point and a given end point. The passage occurrence rate is determined taking into account all of the phases of movement over the ground performed between the given start point and the given end point. For example, the data-managing system 10 selects, from among the obtained data each representative of a route travelled during a phase of movement over the ground, the data representative of the routes travelled between said given start point and said given end point, then determines, for each route the data of which is selected, all the geolocation points of said route. The data-managing system 10 associates an aircraft passage 131 with each geolocation point of each selected route and then determines the passage occurrence rate of at least one aircraft 131 through each geolocation point. The data-managing system 10 then provides at least one determined passage occurrence rate and at least one geolocation point associated with said passage occurrence rate. For example, the display 12 is configured to produce a graphical representation of each passage occurrence rate of at least one determined aircraft for said given start point and given end point. It is then easy to visualize the taxiways through which the highest number of aircraft 131 pass during phases of movement over the ground performed between two given points.

The data-managing system 10 is further configured to obtain data concerning conditions (or characteristics) of movement over the ground of at least one phase of movement over the ground performed by an aircraft 131 of the fleet 13 and to associate the data concerning conditions of movement over the ground of a phase of movement over the ground with each datum representative of an event realized during said phase of movement over the ground. The data concerning conditions of movement over the ground may include temporal information of the phase of movement over the ground, such as a time and date, or even an aircraft type or aircraft weight class. The data concerning conditions of movement over the ground may further include meteorological conditions of each phase of movement over the ground in the airport, such as wind direction and speed, temperature, or atmospheric pressure. Said data are for example obtained from databases of the aircraft 131 of the fleet 13 or from a service providing meteorological data.

The assisting system 1 is further configured to allow the data obtained to be filtered depending on the data concerning conditions of movement over the ground, and the graphical representation 30 to be displayed taking into account said filtering. For example, the assisting system 1, and preferably the display 12 of the assisting system 1, comprises a human-machine interface configured to permit a user to select data concerning conditions of movement over the ground meeting a predefined criterion. The predefined criterion is for example a predefined time period of the day and/or a day of the week and/or a predefined time period of the year and/or a predefined route taken between the start point and the end point of the phase of movement over the ground and/or a predefined aircraft type and/or a predefined meteorological criterion such as wind speed and/or wind direction and/or atmospheric pressure. The assisting system 1 detects said selected predefined criterion and selects the data representative of the event that are associated with associated data concerning conditions of movement over the ground meeting the predefined criterion. The occurrence rate of a predefined event, per geolocation point, and for at least one predetermined route, is then determined taking into account only data representative of the event that were selected during filtering.

It is then possible to easily view only some of the obtained data, i.e. data for which the phase of movement over the ground meets predefined conditions of movement over the ground. For example, it is possible to view the occurrence rate of switch-on of the second propulsion engine only for the phases of movement over the ground that were performed between 6 h and 8 h, in the months of December, January and February. This allows a pilot to identify without particular effort the geolocation point where the highest proportion of the aircraft 131 of the fleet 13 switched on their second propulsion engine under traffic or meteorological conditions considered similar.

According to a first embodiment, the display 12 produces a graphical representation of each occurrence rate of a single predefined event on a given map. According to a second embodiment, the display 12 produces a graphical representation, on a given map, of each occurrence rate of a plurality of predefined events, this making it possible to observe a correlation between the geolocation points where a first predefined event, for example switch-on of the second propulsion engine, is realized and geolocation points where a second predefined event, for example a temperature of the second propulsion engine sufficient to allow take-off, is realized. The pilot may then decide to perform the operation of switching on the second propulsion engine depending on the geolocation point at which she or he expects to obtain a sufficient temperature to allow take-off.

According to one example of embodiment, the assisting system 1 further comprises a processing unit 11, arranged in the aircraft 2 and configured to send, to the data-managing system 10, an occurrence-rate request and to receive, in response to said occurrence-rate request, from the data-managing system 10, data representative of obtained events and/or determined occurrence rates. The processing unit 11 is further configured to provide a datum representative of at least one determined occurrence rate, and for example to transmit the determined occurrence rates to the display 12, when the display 12 is further arranged in the aircraft 2. According to one particular embodiment, the processing unit 11 determines each occurrence rate on the basis of data obtained from the data-managing system 10.

FIG. 2 schematically illustrates the aircraft 2 benefiting from the assisting system 1. According to one embodiment, the assisting system 1 is a system located on board the aircraft 2. According to one embodiment, the data-managing system 10 of the assisting system 1 is a remote system that communicates with the aircraft 2, and the display 12 is located on board the aircraft 2.

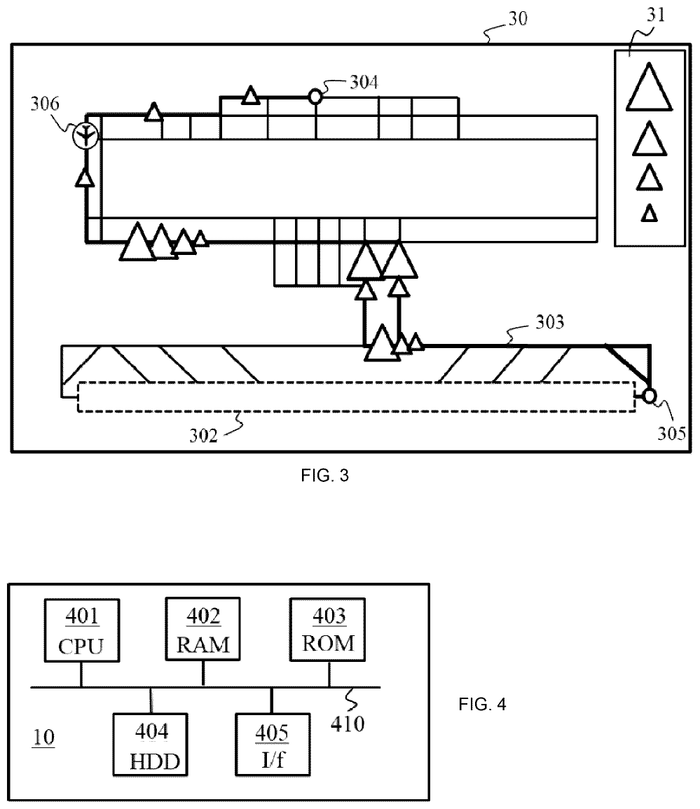

FIG. 3 schematically illustrates a chart 30 resulting from a graphical representation, produced by the display 12, of each occurrence rate. The chart 30 shows taxiways of the airport, which have been represented here by thin continuous lines, and a runway 302, the outline of which has here been drawn with dashed lines. In the illustrated example, the chart 30 includes a route 303, represented by thick continuous lines, between a start point 304 and an end point 305.

The chart 30 further includes a set of indicators each representative of one occurrence rate of a given predefined event, each indicator being illustrated here by a symbol of triangular shape the size of which varies depending on the occurrence rate. The larger the triangular symbol, the higher the occurrence rate. Each indicator is positioned in a zone of the graphical representation 30 corresponding to the geolocation point at which the occurrence rate was determined.

According to one alternative embodiment (not shown), each indicator of the set of indicators is represented by a colored zone the color of which varies with the occurrence rate. The set of indicators is thus represented by a range of colors defined in a predetermined order, for example blue, green, yellow, orange then red, and the color of the indicator gets closer to red as occurrence rate increases.

According to one embodiment, the graphical representation 30 comprises a legend 31 making it possible to explicate the range of sizes of the symbol or the color range, or in other words to explicate a variable characteristic of the set of indicators allowing the variations in the occurrence rate of the event from one geolocation point to another to be visualized.

The pilot may then easily see the geolocation point at which a predefined event was realized in the highest number of considered previous phases of movement over the ground. She or he may thus select a geolocation point at which the indicator is closest to a second predefined criterion, for example closest to a maximum of a range of sizes or colors. The pilot may then easily decide to effect, at said selected geolocation point, an operation associated with the predefined event in question.

According to one embodiment, the assisting system 1 is configured to obtain a geolocation point of the aircraft 2 in real time and to produce a graphical representation of said geolocation point of the aircraft 2 in real time, said geolocation point here being represented in the chart 30 by a symbol 306.

FIG. 4 schematically illustrates one example of a hardware platform allowing the data-managing system 10 to be implemented in the form of electronic circuitry.

The hardware platform comprises the following, connected by a communication bus 410: a processor or central processing unit CPU 401; a random-access memory RAM 402; a read-only memory ROM 403, for example an electrically erasable programmable read-only memory (EEPROM) such as a flash memory, or another type of read-only memory; a storage unit HDD 404, such as a hard disk drive or a storage device reader such as an SD card reader (SD standing for Secure Digital); and an interface manager I/f 405.

The interface manager I/f 405 allows the data-managing system 10 to interact with databases of the aircraft 131 of the fleet 13, with a database of the airport and/or with a service providing meteorological data where appropriate, and with the processing unit 11 and/or the display 12.

The processor 401 is capable of executing instructions loaded into the random access memory 402 from the read-only memory 403, from an external memory, from a storage medium (such as an SD card), or from a communication network. When the hardware platform is powered up, the processor 401 is capable of reading instructions from the random-access memory 402 and of executing them. These instructions form a computer program that causes the processor 401 to implement all or some of the steps, methods and operations described here with reference to the data-managing system 10.

All or some of the steps, methods and operations described here may thus be implemented in software form by executing a set of instructions by means of a programmable machine, for example a digital signal processor (DSP) or a microcontroller, or be implemented in hardware form by means of a machine or of a dedicated chip or chipset, for example a field-programmable gate array (FPGA) or application-specific application circuit (ASIC). Generally, the data-managing system 10 comprises electronic circuitry designed and configured to implement the operations, methods and steps described here in relation to said data-managing system 10.

The processing unit 11 may be implemented by a hardware platform similar to the one illustrated in FIG. 4, in the form of electronic circuitry. In other words, the processing unit 11 comprises electronic circuitry designed and configured to implement the operations, methods and steps described here in relation to said processing unit 11. The interface manager I/f 405 of the processing unit 11 allows the processing unit 11 to interact with the data-managing system 10 and with the display 12, but also where appropriate with the human-machine interface.

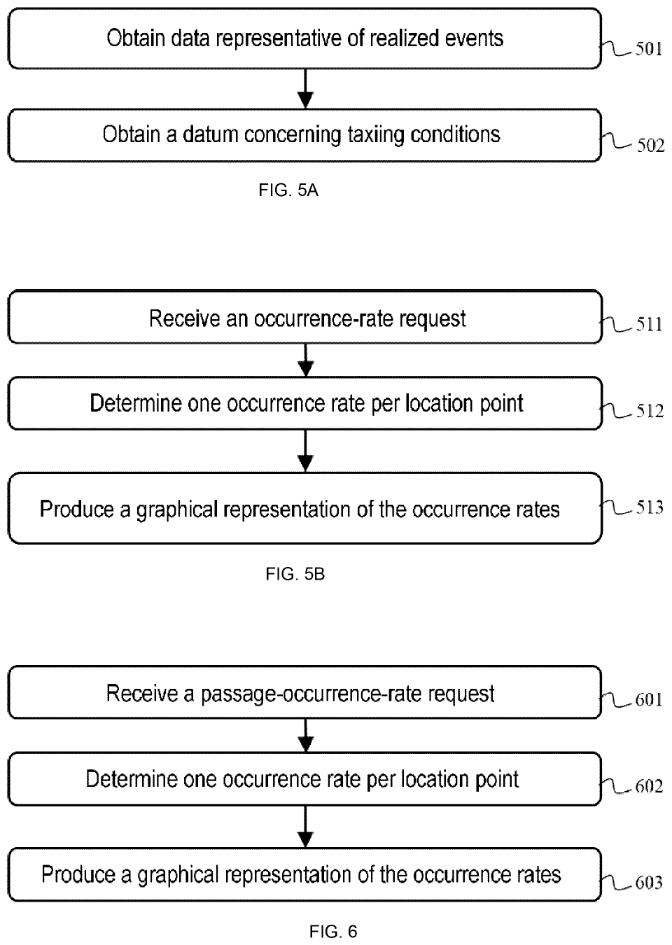

FIG. 5A schematically illustrates first steps of an assisting method implemented by the assisting system 1.

In a first step 501, the data-managing system 10 obtains data representative of at least one event from a list of predefined events, and a geolocation datum associated with each datum representative of an event. The data-managing system 10 converts each obtained geolocation datum into an airport geolocation point. The data-managing system 10 further obtains, for each datum representative of an event realized during a phase of movement over the ground, a datum representative of a route travelled during said phase of movement over the ground.

In a step 502, the data-managing system 10 obtains data concerning the conditions of the phases of movement over the ground and associates, for each phase of movement over the ground, the data concerning the conditions of the phase of movement over the ground with each datum representative of an event realized during said phase of movement over the ground.

FIG. 5B schematically illustrates second steps of the assisting method implemented by the assisting system 1.

In a first step 511, the data-managing system 10 receives an occurrence-rate request, for example from the aircraft 2. Step 511 is implemented each time an occurrence-rate request is received. The occurrence-rate request is for example sent when a pilot triggers dispatch of such a request at the beginning of a phase of movement over the ground. According to one embodiment, the occurrence-rate request is sent by the processing unit 11. The occurrence-rate request comprises a datum representative of at least one specified route, between a given start point and a given end point. The specified route is for example a route to be followed during a phase of movement over the ground of the aircraft 2.

In a subsequent step 512, the data-managing system 10 determines, for the at least one specified route, an occurrence rate of each predefined event realized during a phase of movement over the ground along said at least one specified route, and per geolocation point. To this end, the data-managing system 10 selects, from the set of obtained and available data, each datum representative of a predefined event that is associated with a datum representative of a travelled route identical to the specified route.

According to one embodiment, the occurrence-rate request received in step 511 further comprises at least one predefined event from the list of predefined events. Said at least one predefined event is for example selected by a pilot of the aircraft 2. In this case, the system determines, in step 512, occurrence rates only for each predefined event transmitted in the occurrence-rate request.

In a subsequent step 513, the assisting system 1 provides a datum representative of at least one determined occurrence rate and at least one geolocation point associated with said occurrence rate. For example, the display 12 produces a graphical representation of each occurrence rate of at least one predefined event, via superposition on a map of the taxiways of the airport.

FIG. 6 schematically illustrates optional steps of the assisting method that may be implemented prior to steps 511 to 513.

In a step 601, the data-managing system 10 receives a second occurrence-rate request, called the passage-occurrence-rate request, from an aircraft 2 for example. Step 601 is implemented each time a passage-occurrence-rate request is received.

The passage-occurrence-rate request contains a datum representative of a given start point and of a given end point.

In a subsequent step 602, the data-managing system 10 determines an occurrence rate of passage of at least one aircraft 131 of the fleet 13 through each geolocation point, for said given start and end points.

In a subsequent step 603, the assisting system 1 provides a datum representative of at least one determined passage occurrence rate and at least one geolocation point associated with said passage occurrence rate. For example, the display 12 produces a graphical representation of each determined occurrence rate of passage of at least one aircraft, via superposition on a map of the taxiways of the airport.

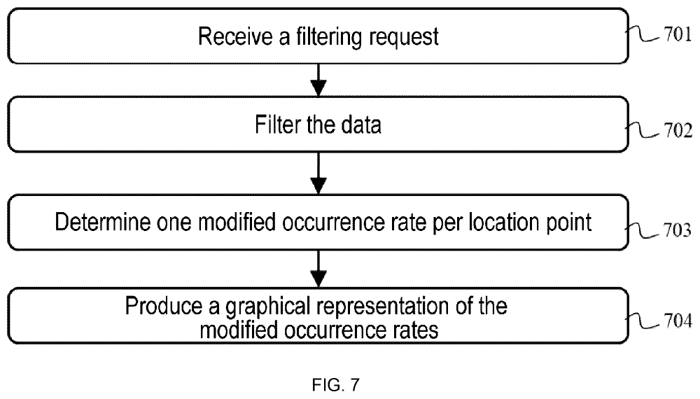

FIG. 7 schematically illustrates filtering steps of the assisting method.

In a step 701, the assisting system 1 receives a filtering request, for example from the human-machine interface, said filtering request comprising at least one filtering criterion from a list of predefined filtering criteria.

In a step 702, the assisting system 1 filters the data representative of events depending on the filtering request. To do this, the assisting system 1 detects the filtering criterion of the filtering request, then selects each datum representative of an event that is associated with a datum concerning a condition or conditions of the phase of movement over the ground meeting said predefined criterion.

In a step 703, the assisting system 1 determines a modified occurrence rate, for each geolocation point, of each predefined event on the basis of the data selected in the preceding step 702.

In a step 704, the assisting system 1 provides a datum representative of at least one modified occurrence rate and at least one geolocation point associated with said occurrence rate. For example, the display 12 produces a graphical representation of each determined modified occurrence rate, via superposition on the taxiways of the airport.

The invention is not limited solely to the described embodiments and examples of embodiment, but more generally encompasses any method allowing a flight crew of an aircraft to be provided with an occurrence rate of a defined event from a list of predefined events previously realized by other aircraft (ideally of the same type), during a phase of movement over the ground in the same airport, and at least one geolocation point associated with the provided occurrence rate. For example, the presumed ideal location to switch on a second engine may be indicated to pilots when the first engine is switched on, based on previous events.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

Claimed is:

1. A method for assisting with operations to be effected in an aircraft, during a phase of movement over the ground in an airport, the method comprising:
obtaining, for at least one phase of movement over the ground performed in a given airport, by an aircraft of a fleet of aircraft, and depending on a route travelled, one or more data each representative of one event realized during said at least one phase of movement over the ground, the one event being chosen from a list of predefined events, each predefined event in the list of predefined events being associated with at least one operation to be effected in the aircraft, and a geolocation point at which said event was realized,
obtaining, in association with each one or more data representative of an event, at least one datum concerning a condition or conditions of the at least one phase of movement over the ground,
determining, for at least one predetermined route, an occurrence rate of each predefined event realized during a phase of movement over the ground along said predetermined route, and per geolocation point, on a basis of the one or more data obtained, the occurrence rate of each predefined event being determined solely on a basis of the one or more data representative of the one event for which the at least one condition of the phase of movement over the ground meets at least one predefined criterion, and
providing a datum representative of at least one determined occurrence rate and at least one geolocation point associated with said occurrence rate.

2. The method according to claim 1, wherein providing a datum representative of at least one determined occurrence rate and at least one geolocation point associated with said occurrence rate comprises generating a graphical representation of each determined occurrence rate, via superposition on a map of taxiways of the airport.

3. The method according to claim 1, further comprising:
determining, for a given start point and a given end point, a passage occurrence rate of at least one aircraft of the fleet per geolocation point of at least one route travelled during a phase of movement over the ground between the given end point and the given start point, and
providing a datum representative of at least one determined passage occurrence rate and at least one geolocation point associated with said passage occurrence rate.

4. The method according to claim 3, wherein providing a datum representative of at least one determined passage occurrence rate and at least one geolocation point associated with said passage occurrence rate comprises generating a graphical representation of each determined passage occurrence rate, via superposition on a map of taxiways of the airport.

5. The method according to claim 1, wherein a first event in the list of predefined events comprises switching on a second propulsion engine of the aircraft.

6. The method according to claim 5, wherein a second event in the list of predefined events comprises a temperature state of the second propulsion engine sufficient to permit take-off.

7. The method according to claim 1, wherein the at least one predefined criterion comprises a time period of a day, a day of a week, a time period of a year, an aircraft type, a meteorological criterion, or any combination thereof.

8. The method according to claim 1, further comprising:
selecting at least one geolocation point at which the occurrence rate of a predefined event is highest, and
initiating automatic piloting comprising effecting, at said selected geolocation point, an operation associated with said predefined event.

9. A system for assisting with operations to be effected on the ground, in an aircraft, during a phase of movement over the ground performed in a given airport, the system comprising:
electronic circuitry configured to:
obtain, for at least one phase of movement over the ground performed in a given airport, by an aircraft of a fleet of aircraft, and depending on a route travelled, one or more data each representative of one event realized during said at least one phase of movement over the ground, the one event being chosen from a list of predefined events, each predefined event in the list of predefined events being associated with at least one operation to be effected in the aircraft, and a geolocation point at which said one event was realized,
obtaining, in association with each one or more data representative of an event, at least one datum concerning a condition or conditions of the phase of movement over the ground,
determining, for at least one predetermined route, an occurrence rate of each predefined event realized during a phase of movement over the ground along said predetermined route, and per geolocation point, on a basis of the one or more data obtained, the occurrence rate of each predefined event being determined solely on a basis of the data representative of the one event for which the at least one condition of the phase of movement over the ground meets at least one predefined criterion, and
providing a datum representative of at least one determined occurrence rate and at least one geolocation point associated with said occurrence rate.
